(19) United States
(12) Patent Application Publication
(10) Pub. No.: US 2012/0174786 A1
(43) Pub. Date: Jul. 12, 2012

(54) EXTERNAL AIR FILTER AND FRAME FOR COMPUTING DEVICES

(76) Inventor: Josh Sahley, Culver City, CA (US)

(21) Appl. No.: 13/004,854

(22) Filed: Jan. 11, 2011

(51) Int. Cl. B01D 46/00; B01D 46/42

(52) U.S. Cl. 95/278; 55/385.6; 95/273

(57) ABSTRACT

The present invention comprises a filter system for a computing device including a frame. In one embodiment, end members on the frame are biased toward each other so that, when the frame is mounted on a cabinet of the computing device, the opposing end members tightly fit around a portion of the cabinet, the filter fitting within the frame. In one embodiment, a majority of the filter is visible to the user, largely unobstructed by the frame. As a result, the status of the filter may be evident to the user, thereby facilitating its cleaning or replacement. In some embodiments, the user may clean the filter in place, and in some embodiments, the user may easily remove the frame with its opposing end members from the computer cabinet thereby permitting the filter to be easily cleaned or replaced.

### BACKGROUND OF THE INVENTION

1. Field of the Invention

This invention relates to the field of air filters for computing devices and more particularly to a frame and filter designed to be attached to the outside of a computing device housing or tower, such as for a personal desktop computer, stereo, or videogame device, mobile computing device, laptop, mini, or other device that comprises a plurality of electronic components enclosed within a cabinet in which ventilation is provided.

2. Description of the Related Art

The electronic components of a computer are typically contained within an enclosure, such as a case or a cabinet. For a personal desktop computer, this cabinet is commonly called a tower. During operation, however, many of these electronic components produce a considerable amount of heat, and the cabinet has the tendency to trap and allow this heat to accumulate. As a result, computer manufacturers employ ventilation devices, mostly rotary fans, to circulate air around the heat producing electronic components and carry away the heat in an effort to prolong the proper functioning of the computer.

Although this circulated air is useful for carrying away the produced heat, this method quickens the rate at which dust particles and impurities that are resident in the air accumulate inside a computer. The build-up of a large quantity of accumulated dust particles and impurities, some of which involves highly conductive materials, can lead to a breakdown of the computer.

As a result, several attempts have been made to filter the air introduced into the computer cabinet by such air circulation systems. One problem with some of these computer cabinet air filters is that the end users rarely clean them or replace them. Over time, if the filter is not periodically cleaned or replaced, the cooling fan can become much less effective at cooling the electronic components inside the cabinet, exposing the components to the risk of overheating.

### SUMMARY OF THE INVENTION

The present invention comprises a filter system for a computing device including a frame. In one embodiment, end members on the frame are biased toward each other so that, when the frame is mounted on a cabinet of the computing device, the opposing end members tightly fit around a portion of the cabinet, the filter fitting within the frame. In one embodiment, a majority of the filter is visible to the user, largely unobstructed by the frame. As a result, the status of the filter may be evident to the user, thereby facilitating its cleaning or replacement. In some embodiments, the user may clean the filter in place, and in some embodiments, the user may easily remove the frame with its opposing end members from the computer cabinet thereby permitting the filter to be easily cleaned or replaced.

### BRIEF DESCRIPTION OF THE DRAWINGS

FIG. 1 is a perspective view of one embodiment of the present invention.

FIG. 2 is an exploded view of the embodiment of FIG. 1.

FIG. 3 is a perspective view of another embodiment of the present invention.

FIG. 4 is an exploded view of another embodiment of the present invention.

FIG. 5 is an exploded view of the embodiment of FIG. 4 as viewed from above.

FIG. 6 is a perspective view of another embodiment of the present invention.

FIG. 7 is a perspective view of another embodiment of the present invention.

### DESCRIPTION OF THE PREFERRED EMBODIMENT(S)

The detailed description set forth below in connection with the appended drawings is intended as a description of presently-preferred embodiments of the invention and is not intended to represent the only forms in which the present invention may be constructed and/or utilized. The description sets forth the functions and the sequence of steps for constructing and operating the invention in connection with the illustrated embodiments. It is to be understood, however, that the same or equivalent functions and sequences may be accomplished by different embodiments that are also intended to be encompassed within the spirit and scope of the invention.

The present invention is an air filter for a computing device such as a personal desktop computer, stereo, or videogame device, mobile computing device, laptop, mini, or any other device that comprises a plurality of electronic components enclosed within a cabinet in which ventilation is provided. The device is configured to facilitate and promote its proper maintenance, one embodiment of which is an aftermarket filter and frame that can be attached to the outside of a stereo cabinet or cabinet of a personal computer, and another embodiment of which is a smaller version that can be attached to the outside of the case of a laptop or smaller computer device. In either embodiment, the filter is easily accessible so that it can be easily cleaned or replaced. Many laptops and computer towers either have no filter or, at most, have an internal filter that is not easily observed, cleaned or replaced. As a result, such common filter systems are rarely cleaned or replaced, causing the components inside the machine to overheat and fail.

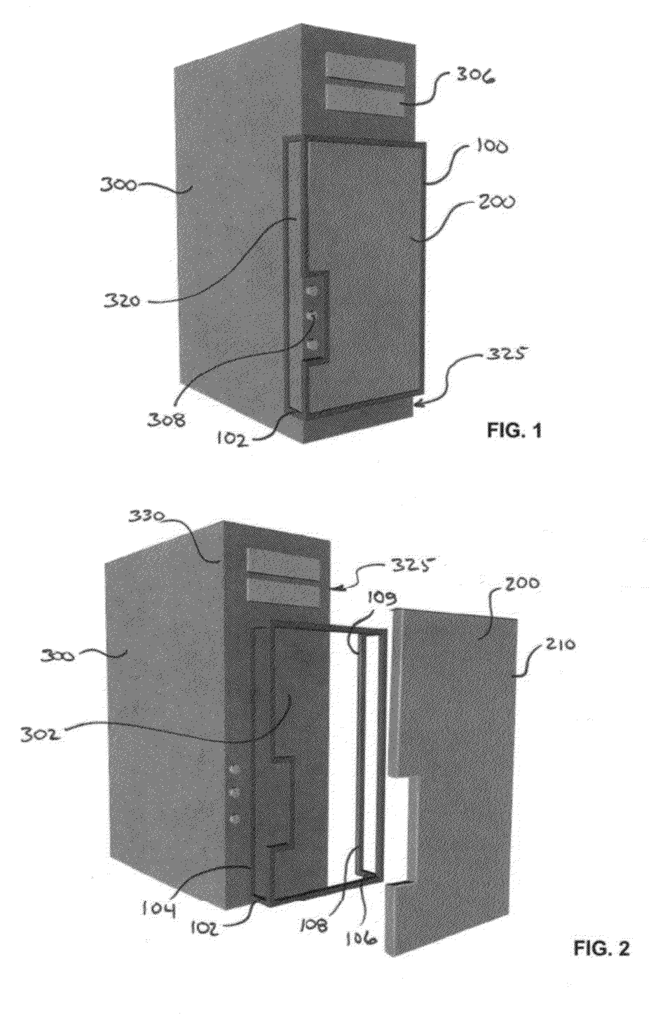

The frame 100 and filter 200 can be mounted on the computer in many ways. For example, the frame 100 may be designed to be snug-fit around the portion of the tower cabinet (or laptop case, iMac, or the like) that takes in the outside air or by using clips, elastic bands, or hook-and-loop-type fastener materials without resorting to using any adhesive or fasteners that could mar the surface of the cabinet walls or leave a messy residue. FIGS. 1 and 2 illustrate one such embodiment in which the frame 100 comprises opposing end members 102 and 104 that are configured to grip around substantially parallel opposing walls 320 and 325 or 330 and 335 of the cabinet 300. Most cabinets for personal computers have at least two opposing walls that are substantially parallel to one another. On some cabinets, these two opposing walls are the side walls 320 and 325 of the cabinet 300. On others, these two opposing walls are a top wall 330 and bottom wall 335. On many cabinets for such computing devices, stereos, videogames, and the like, the side walls 320, 325 are substantially parallel, and the top and bottom walls 330, 335 are also substantially parallel.

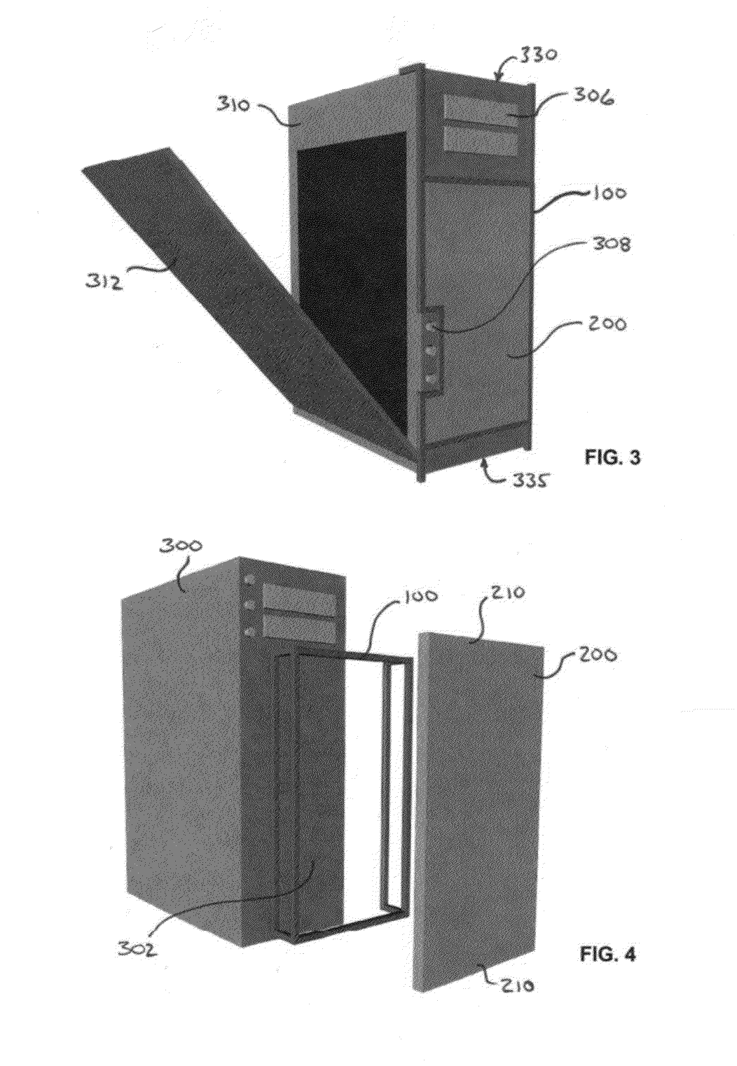

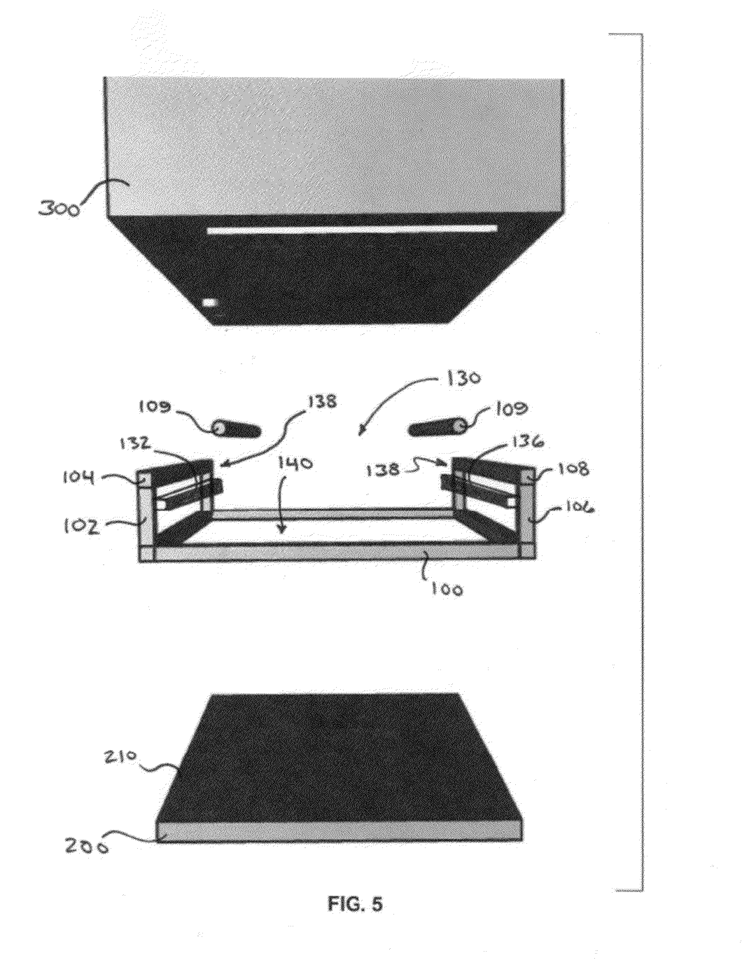

The end members 102, 104 of the frame 100 shown in FIGS. 1 and 2 are configured to grip the outside of substantially parallel opposing side walls 320 and 325. The end members 102, 104 of the frame 100 in FIG. 3 are configured to grip the outside of substantially parallel opposing top and bottom walls 330 and 335. The end user may choose the preferred orientation of the end members 102, 104 based on a number of factors, including which orientation interferes the least with the opening and closing of any cabinet door 312, the removal and replacement of any cabinet cover 305, access to any data disk slots 306 or external buttons 308, etc.

In this embodiment of the present invention, the end members 102, 104 may be made of a durable material, biased slightly toward each other, and sufficiently flexible enough to permit the user to pull the distal edges 106 and 108 of end members 102 and 104 away from each other for the purpose of removing the frame 100 from the computer cabinet 300 and re-mounting the frame 100 onto the computer cabinet 300. In order to accommodate a substantial number of computer cabinets presently on the market and anticipated for the near future, the end members 102 and 104 can be extended a combined at least approximately three-quarters (¾) inches from their initially biased positions, and more preferably a combined at least approximately one and one-quarter (1¼) inches from their initially biased positions, and most preferably a combined at least approximately 2 inches from their initially biased positions. As a result, the user may remove the frame 100 from the computer cabinet 300 simply by pulling the distal edges 106, 108 of the end members 102, 104 away from each other and simultaneously sliding the frame 100 unimpeded in a direction away from the cabinet 300—at least far enough to remove the filter 200 contained within the frame 100.

In other embodiments, the end members 102, 104 may grip the walls 320, 325 of the computer cabinet using one or more spring mechanisms—torsion springs, leaf springs, compression springs, tension springs, or the like—made of metal with the requisite biasing, durability, and flexibility. Notably, in may of the foregoing embodiments, the end members 102, 104 are configured attach the frame to the cabinet without relying on messy adhesives, scratching the cabinet 300, or otherwise requiring intrusive or destructive effects on the cabinet walls 320, 325.

Once the filter 200 is removed, it is contemplated that the filter 200 might be replaced or, if it is reusable, cleaned and returned. The user may then return the frame 100 to its operational position around a portion of the cabinet 300 by pulling again outward on the two distal edges 106, 108 of the end members 102, 104, sliding the frame 100 into place, and then allowing the end members 102, 104 to return to their initially biased positions so that they grip the opposing walls 320, 325 of the cabinet. Additionally, the distal edges 106, 108 of end members 102, 104 may have one or more friction members 112.

Other structural members 132 and 136 of the frame 100 define one or more air passages 140 and a filter cavity 130. A filter 200 fits into the filter cavity 130 and is pressed against the computer cabinet 300 when the frame 100 is in place as described above so that the air drawn into the cabinet 300 must pass through the air passages 140 and filter 130. In order to facilitate easy removal and replacement of the filter 200 in one embodiment of the present invention, the structural members 132, 136 of the frame 100 further comprise one or more filter receiving slots 138, and the filter 200 comprises one or more edge regions 210 configured to be received in the one or more filter receiving slot or slots 138.

In one embodiment, the one or more filter receiving slots 138 are in mechanical communication with the frame end members 102, 104 such that when the frame 100 is in place and gripping the cabinet 300, the filter 200 is pressed against the cabinet 300, and when the user pulls the distal edges 106, 108 of the end members 102, 104 away from one another, the one or more filter receiving slots 138 are in turn rotated or moved in a manner that releases the filter 200 and makes it predisposed to being removed.

In one preferred embodiment, the structural members 132, 136 insure that the air drawn into the computer cabinet 300 necessarily passes through the filter 200 without resorting to using any adhesive or fasteners that could mar the surface of the cabinet walls or leave a messy residue. Also, in a preferred embodiment, the filter 200 and frame 100 may be shaped to avoid obscuring regions of the cabinet 300 that contain doors, buttons, disk drives, other ports, etc., and therefore does not need to be moved in order for the user to have access thereto. The filter 200 would then cover only so much of the computer's surface to ensure that the filter is fixed over the air intake region without impeding in any way the user's access to the external buttons or even the internal components of the computer.

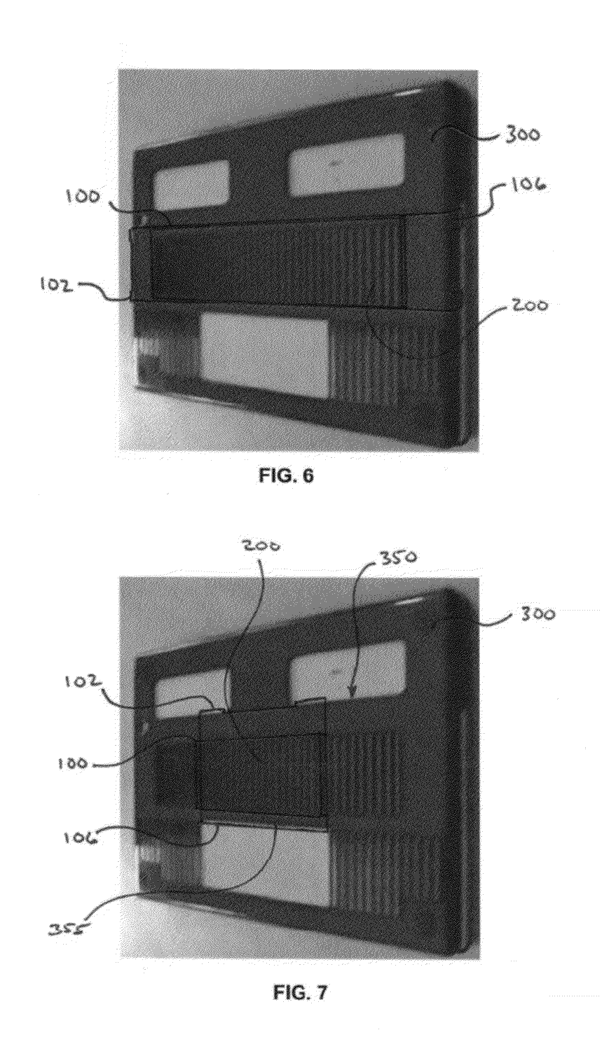

In a related embodiment, the end members 102, 104 of the frame 100 are more like clips that encounter very thin opposing walls or opposing edges of a single wall of the cabinet 300. For example, in some computers, the air intake region of a computer cabinet is on a wall that has thin opposing edges—or has or adjoins opposing side walls that are relatively thin. To meet such applications, the end members 102, 104 of the frame 100 may be designed to clip around the thin opposing edges or adjoining side walls 320, 325. FIGS. 6 and 7 show embodiments in which the frame 100 and filter 200 are configured to attach to the cabinet of a laptop or iMac computer. The air intake region is on the underside of many laptop computer models, and the wall surrounding the air intake region 302 has thin opposing edges 350 and 355 as well as opposing side walls 320 and 325 that are relatively thin. In such situations, the opposing end members 102 and 104 of the frame 100 are configured to clip around these thin cabinet wall edges 350 and 355 (as in FIG. 7) or side walls 320 and 325 (as in FIG. 6). The laptop configuration could alternatively be a full cover, comprising a clear or colored plastic with one or more air passages 140 under which the filter 200 is positioned, thereby providing smooth surface with less obtrusions, given the nature of the user of a laptop or iMac computer.

Additionally, in one embodiment of the present invention, a majority of the filter is visible to the end user when the filter and frame are in place and in use so that the end user can readily monitor whether the filter appears clean or clogged with debris. As a result, the end user will most likely be more vigilant about keeping the filter clear of debris and, consequently, the keeping the internal components of the computer cooled by as much clean, filtered air as possible. Indeed, with some embodiments of the present invention, upwards of 50%, 75%, and even 90% or 95% of the surface of the filter 200 is visible and not obscured by the frame 100. This greatly increases the number of computer models that a single embodiment can fit since different models place the air intake region in different places. Thus, an only-minimally-obscured filter is more likely to present to the user the clear or clogged status regardless of which computer model it is mounted to. Additionally, on many models, then, the filter cleaned in situ, without even having to remove the filter, such as with a lint brush, a specialty brush, moist towelettes, or tape sold separately or with the filter.

In some embodiments, the filter is selected from material, texture, and color scheme that will facilitate cleaning in place, including filters having at least one small-pore surface that permits the passage and filtration of air in a manner such that particulate matter in the air is stopped at the surface rather than allowed to migrate deep into the filter. As a result, this configuration further facilitates a process of cleaning the filter in place by using a lint brush, moist towelettes, or the like. Such filter surfaces may, for example, include such smooth small-pore or micro-porous foam or nylon materials, and or a plastic or metal mesh or other breathable film or surface. The color could be any color that readily contrasts with the dark appearance of most airborne particulate matter, such as light, bright colors as well as shiny or matte black colors.

While the present invention has been described with regards to particular embodiments, it is recognized that additional variations of the present invention may be devised without departing from the inventive concept.

What is claimed is:

1. A filter system for a computing device comprising:
a frame;
at least two opposing end members attached to or formed on the frame and biased toward each other so that when the frame is mounted on a cabinet of the computing device the opposing end members tightly fit around a portion of the cabinet;
one or more air intake openings formed on one face of the frame configured to lie substantially over an air intake region of the computing device; and
a filter configured to fit within the frame between the air intake openings of the frame and the air intake region of the computing device such that air passing through the air intake openings will encounter the filter;
wherein at least a portion of the filter is visible through the at least one of the one or more air intake openings when the filter is in use to provide an indicator of the amount of particulate matter accumulating on the filter; and
wherein the frame with its opposing end members is configured to be easily removed from the computer cabinet by the end user permitting the filter to be easily removed for purposes of cleaning or replacement.

2. The filter system of claim 1 wherein the frame and filter are shaped to avoid obscuring operational buttons on the cabinet of the computing device.

3. The filter system of claim 1 wherein the end members are sufficiently flexible to be pulled away from each other up to a cumulative approximately ¾ inch from their initially biased distance.

4. The filter system of claim 1 wherein the end members are sufficiently flexible to be pulled away from each other up to a cumulative approximately 1¼ inch from their initially biased distance.

5. The filter system of claim 1 wherein the end members are sufficiently flexible to be pulled away from each other up to a cumulative approximately 2 inches from their initially biased distance.

6. The filter system of claim 1 further comprising structural members that define one or more filter receiving slots for guiding and receiving a portion of the filter upon insertion and for holding the filter in place when in use.

7. The filter system of claim 1 wherein the frame obscures less than 50% of the outer surface of the filter.

8. The filter system of claim 1 wherein the frame obscures less than 25% of the outer surface of the filter.

9. The filter system of claim 1 wherein the frame obscures less than 10% of the outer surface of the filter.

10. The filter system of claim 1 wherein the frame and filter are configured to be cleaned by the user while the filter sits within the frame.

11. A method of filtering for a computing device, comprising:
providing a frame;
providing at least two opposing end members attached to or formed on the frame and biased toward each other so that when the frame is mounted on a cabinet of the computing device the opposing end members tightly fit around a portion of the cabinet;
providing one or more air intake openings formed on one face of the frame configured to lie substantially over an air intake region of the computing device; and
providing a filter configured to fit within the frame between the air intake openings of the frame and the air intake region of the computing device such that air passing through the air intake openings will encounter the filter;
wherein at least a portion of the filter is visible through the at least one of the one or more air intake openings when the filter is in use to provide an indicator of the amount of particulate matter accumulating on the filter; and
wherein the frame with its opposing end members is configured to be easily removed from the computer cabinet by the end user permitting the filter to be easily removed for purposes of cleaning or replacement.

12. The method of claim 11 wherein the frame and filter are shaped to avoid obscuring operational buttons on the cabinet of the computing device.

13. The method of claim 11 wherein the end members are sufficiently flexible to be pulled away from each other up to a cumulative approximately ¾ inch from their initially biased distance.

14. The method of claim 11 wherein the end members are sufficiently flexible to be pulled away from each other up to a cumulative approximately 1¼ inch from their initially biased distance.

15. The method of claim 11 wherein the end members are sufficiently flexible to be pulled away from each other up to a cumulative approximately 2 inches from their initially biased distance.

16. The method of claim 11 further comprising providing structural members that define one or more filter receiving slots for guiding and receiving a portion of the filter upon insertion and for holding the filter in place when in use.

17. The method of claim 11 wherein the frame and filter are shaped to avoid obscuring operational buttons on the cabinet of the computing device.

18. The method of claim 11 wherein the frame obscures less than 25% of the outer surface of the filter.

19. The method of claim 11 wherein the frame obscures less than 10% of the outer surface of the filter.

20. The method of claim 11 wherein the frame and filter are configured to be cleaned by the use while the filter sits within the frame.
